(19) United States
(12) Patent Application Publication
(10) Pub. No.: US 2007/0256714 A1
(43) Pub. Date: Nov. 8, 2007

(54) Cleaning Device for Cleaning Welding Torches

(76) Inventors: Georg Binder, Pettenbach (AT); Harald Langeder, Pettenbach (DE)

Correspondence Address: WILLIAM COLLARD;COLLARD & ROE, P.C., 1077 NORTHERN BOULEVARD, ROSLYN, NY, 11576, US

(21) Appl. No.: 11/547,928

(22) PCT Filed: Mar. 23, 2005
(86) PCT No.: PCT/AT05/00106

§ 371 Date: Oct. 31, 2006

(30) Foreign Application Priority Data
Apr. 7, 2004 (AT) GM 260/2004

(51) Int. Cl. B08B 3/00; B23K 9/032

(52) U.S. Cl. 134/43; 134/99.2; 134/56 R; 134/94.1

(57) ABSTRACT

The invention relates to a cleaning device, for the cleaning of welding torches, comprising a device, for cleaning the welding torch, made of a coil with an opening, for the introduction of the welding torch, and optionally, a device for the application of cleaning fluid to the tip of the welding torch. According to the invention, such a cleaning device, which provides a rapid and possibly automated cleaning, particularly suitable for welding robot applications and which is of the simplest and cheapest construction, may be achieved, whereby at least one second device, for cleaning the welding torch, embodied to clean the welding torch by means of a cold medium, in particular with CO₂-dry ice, is arranged in a common housing, in addition to the device for magnetic cleaning and a common controller, a common input/output device and a common power supply or current source for the control, adjustment and energy supply of the cleaning devices are arranged in the housing.

The invention relates to a cleaning device for cleaning welding torches, including a device for the electromagnetic cleaning of the welding torch, which is comprised of a coil having an opening for the introduction of the welding torch and, optionally, a device for the application of cleaning fluid to the tip of the welding torch.

During welding procedures, welding torches are dirtied by molten metal spatters.. Metal spatter will also deposit, and solidify, within the gas nozzle of a welding torch. As a result, the shielding gas flow through the gas nozzle will be disturbed by the deposited metal spatter such that atmospheric air too will be able to reach the welding site and, hence, negatively affect the welding process. A perfectly operating and largely clean welding torch is, therefore, important for the production of a high-quality weld.

Welding torches are, therefore, regularly cleaned from adhering metal spatters. During cleaning, the welding torch is not available for welding operations. It is therefore, sought to perform such cleaning procedures as rapidly as possible. There are mechanical methods for cleaning welding torches, by which deposits are removed from the tip of a welding torch by the aid of brushes, blades or the like. By such mechanical cleaning methods, it is, however, feasible only to a limited extent to clean the interior of the gas nozzle of a welding torch as perfectly as possible.. Moreover, the components of a welding torch will be damaged by mechanical actions so that their service lives will be reduced accordingly. Damage to the surfaces of the welding torch components will even promote the adherence of weld spatter, which will result in a more rapid obstruction of the gas nozzle and require frequent cleaning of the welding torch. The welding torch should, moreover, be cooled prior to the cleaning procedure, which would again extend the cleaning time.

U.S. Pat. No. 4,838,287 A describes a method and device for the cleaning of welding torches, which permit the contactless cleaning of a welding torch by using a coil through which electric current flows. To this end, the tip of the welding torch is introduced into the opening of the coil and a suitable current pulse is applied. The resulting electromagnetic field generates appropriate magnetic forces also acting on the deposits on the welding torch and, hence, removing the same. During the removal of the deposits, no mechanical action is exerted on the welding torch components such that the latter will be spared and their service lives will be increased. To cool the welding torch prior to electromagnetic cleaning, on the one hand, and also facilitate the removal of foreign substances by suitable cleaning agents, on the other hand, the welding torch is usually immersed into a liquid. That liquid may comprise water or mixtures of water with special solvents. For an efficient electromagnetic cleaning, it will be advantageous if the metal spatters on the welding torch are rapidly cooled by immersion into a cleaning liquid. Due to different thermal expansions of the metal spatters and a gas nozzle usually made of copper, such a rapid cooling will, thus cause a reduction of the adherence of metal spatter on the welding torch.

An arrangement for cleaning welding torches, comprising a liquid-filled tub for immersing the welding torch and a coil for electromagnetically cleaning the welding torch is, for instance,. described in WO 01/56730 A2. There, a post carrying the liquid tub and the coil is arranged directly beside the workpiece to be welded such that the welding torch, which is, in particular, mounted to a robot arm, will be automatically cleaned even between welding procedures. It is, however, disadvantageous that there is, for instance, no place on the post for power supply means to the coil such that the latter have to be connected by appropriate lines. Such lines provided between the power supply and the cleaning unit may transmit electromagnetic fields derived from the high current pulses, which may lead to failures of other appliances or control systems.

DE 100 63 572 A1 relates to a method and apparatus for cleaning welding torches, for instance, in automated welding lines, on welding robots and in customized welding processes, using a cold medium, preferably CO₂ dry ice, wherein a compressed-air flow loaded with CO₂ dry ice is directed uniformly or intermittently, by the aid of a jet nozzle, unilaterally onto the surface to be cleaned while performing a rotational movement.

The object of the present invention consists in providing a cleaning device of the initially defined kind, which supports rapid and automatizable cleaning and is especially suited for welding robot applications. In addition, the device is to be structured as simply and cost-effectively as possible.

The object according to the invention is achieved by an above-identified device for cleaning welding torches, wherein, in addition to the device for magnetic cleaning, at least one further device for cleaning the welding torch is arranged in a common housing, which further device is configured to clean the welding torch with a cold medium, in particular CO₂ dry ice, and that a common controller, a common input/output device and a common power supply or current source for the control, adjustment and energy supply of the cleaning devices are arranged in the housing.

The use of different cleaning methods in a common cleaning device offers the advantage that the optimum cleaning method can always be used for the welding torch, i.e., the optimum cleaning method can be selected as a function of the application of the welding torch and as a function of the welding materials employed. At the same time, this allows for a considerable cost reduction of such a cleaning device, since the different cleaning devices share common components like, for instance, a common housing, a common current source, a common controller, a common input/output device etc. Also, it is advantageous that the different devices can be sequentially passed so as to ensure even more thorough cleaning of the welding torch. The operating step of moving the welding torch from one device to a further device during the cleaning of the welding torch can, thus, be as short as possible or even omitted so as to substantially reduce the cleaning time. Such slight position changes, however, require only very little time, for which reason the cleaning method can nevertheless be very rapidly performed. By contrast, in conventional cleaning methods, the welding torch must be moved from an autonomous cleaning station to the next autonomous cleaning station during the cleaning procedure, with the welding torch having to be newly positioned every time and such repositioning optionally having to be repeated several times. These operating steps require additional time and, hence, increase the cleaning time of the welding torch, during which the latter will not be available to the welding process. With such methods, when putting the welding robot into operation, the position must be defined as a function of the number of cleaning devices, i.e., for instance, twice.

Other advantageous configurations are described in claims 2 to 7.

The present invention will be explained in more detail by way of the accompanying drawings, which illustrate exemplary embodiments of the invention. Therein:

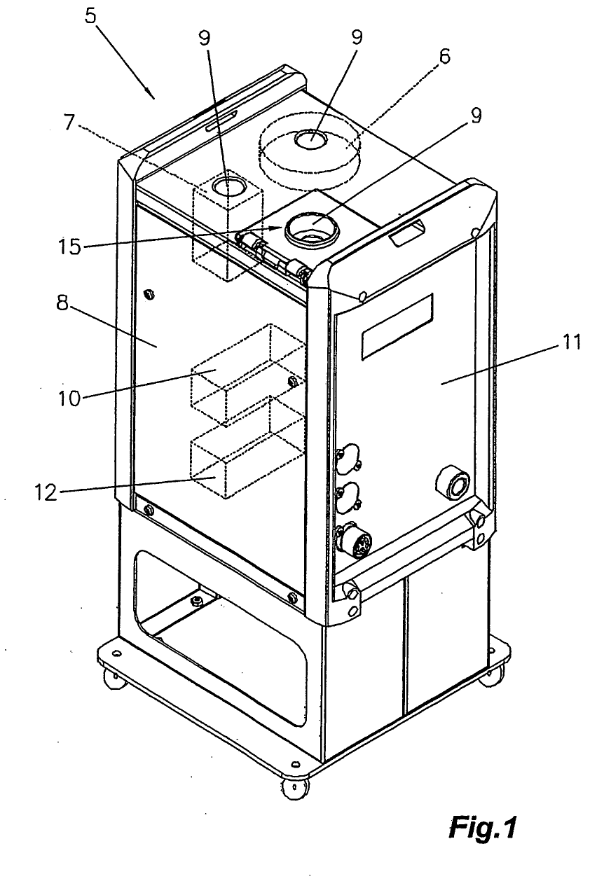

FIG. 1 is a perspective view of a cleaning method according to the invention;

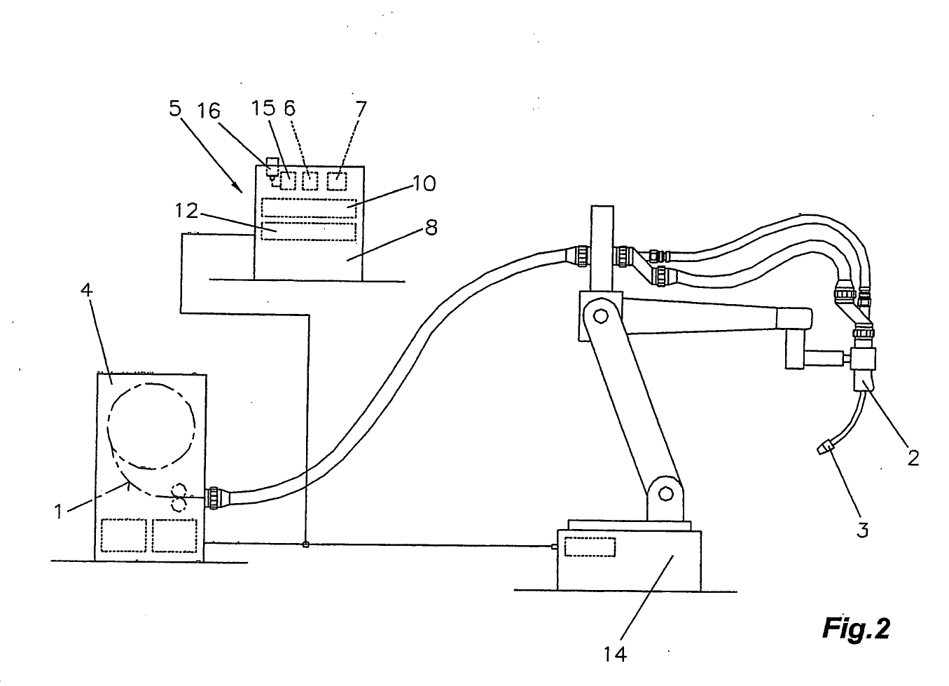

FIG. 2 is a graphical representation of a robot welding installation comprising a line-connected cleaning device; and

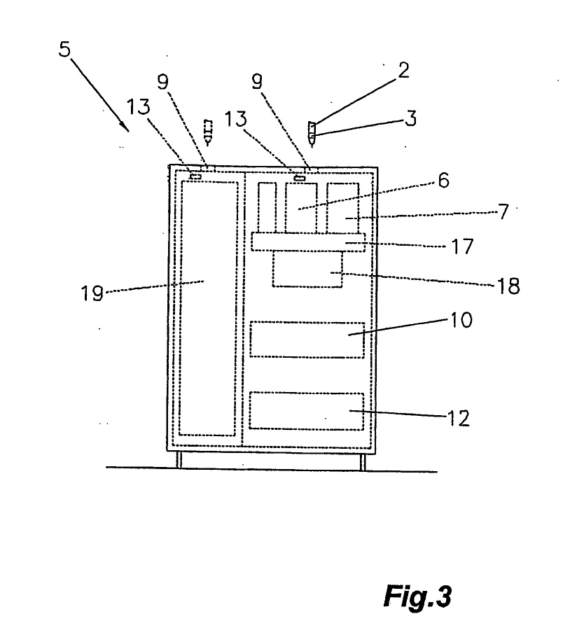

FIG. 3 is a schematic illustration of the cleaning device in side view.

Since different welding materials and different welding wires 1 are frequently used in welding technology, thus causing different weld spatters to remain adhered to a welding torch 2, particularly on or in a gas nozzle 3, or since different welding units or welding apparatus 4 using different welding materials are employed, it is frequently necessary to use different cleaning methods for the welding torch 2. To this end, different cleaning devices 6, 7 for cleaning the welding torch 2 are now arranged in the cleaning device 5 or cleaning appliance according to the invention and can be accordingly selected automatically or by a user.

In the prior art, just a single device 6 or 7 has, as a rule, always been configured as an autonomous device such that in many cases several different appliances have had to be used to optimally clean the welding torch 2. This involves the disadvantage that, consequently, every independent appliance has to be appropriately installed and cabled and, at the same time, an increased amount of space is required.

FIG. 1 is a perspective view of the cleaning device 5 comprising a housing 8, which is designed as a cabinet. The housing 8 contains all the components provided for the cleaning of the welding torch 2. In the exemplary embodiment illustrated, two devices 6, 7 are provided. These devices 6, 7 are preferably arranged in the interior of the housing 8, wherein openings 9 are provided in the housing 8, through which the welding torch 2 can be introduced into the individual components or devices 6, 7. Since the functional sequences or cleaning procedures as well as the structural components required are already known from the prior art, these will not be described in detail, with the illustrations being limited to schematically indicated functional blocks.

FIG. 1, for instance, depicts a combination of a device 6 for magnetic cleaning with a device 7 for CO₂ dry ice cleaning. To this end, it is now provided that the individual devices 6, 7 for cleaning the welding torch 2 are arranged in the common housing 8. Moreover, a common controller 10, a common input/output device 11 and a common power supply 12 for controlling, adjusting and feeding energy to the different devices 6, 7 are arranged in the housing 8. Due to the joint utilization of components or assemblies such as, for instance, the power supply 12, the controller 10 etc., a considerable space saving in the housing 8 has become feasible so as to allow the space demand of such a device to be kept as small as possible. Basically, the user can choose between a particular device 6 or 7 such that, subsequently, the appropriate software or control sequences and data for that particular device 6 or 7 can be loaded and controlled by the controller 10. To this end, sensors 13 may also be arranged on or in the housing 8, particularly in the region of the openings 9, so as to enable the controller 10 to recognize whether a welding torch 2 is present in the opening 9 and how the position, particularly penetration depth, of the welding torch is, whereupon the cleaning process can be started.

When using sensors 13, it is, of course, also possible to implement the automatic activation of the respective device 6 or 7. The robot 14 can, for instance, move to a particular opening 9 into which the welding torch 2 is being introduced. The sensor 13 will recognize the presence of the welding torch 1 in the opening 9, thus causing the controller 10 to activate the respective device 6 or 7 for cleaning the welding torch 2.

For the device 6 for the magnetic cleaning of a welding torch 2, a tub 15 is, for instance, provided in the housing 8 to receive a liquid, preferably a special cleaning liquid, into which the welding torch 2 is immersed to cool the metal spatter adhering thereto. Beside the tub 15, a refill container 16 as apparent from FIG. 2, for instance in bottle form, may be arranged to supply the tub 15 with liquid. Behind the tub 15, the coil of the device 6 is placed in an opening 9 of the housing 8. The welding torch 2 is inserted into the coil after having been immersed into the tub 15, and the coil is activated by the controller 10, i.e. the supply of energy is initiated. After having supplied the coil with electric power, i.e. by activating the device 6, the metal spatter on the welding torch 2 is removed in a contactless manner. The exact functioning sequence is not elucidated, since this can be taken from the prior art documents cited. After having activated the coil, the impurities will fall into a waste bin arranged below the coil (not illustrated). The waste bin can be readily removed and emptied by opening a part of the housing 8.

With this cleaning method, it is also possible to provide an accordingly large refill container within the housing 8 instead of the refill container 16 in bottle form and connect it with the tub 15 via a conduit and a pump (not illustrated). This will ensure particularly long periods of use of the cleaning device 5, which is of particular relevance to the motorcar industry with its robot welding units 14. The refilling of the tub 15 with liquid preferably takes place fully automatically.

Furthermore, the device 7 for cleaning the welding torch 2 with cold medium is integrated in the housing 8 of the cleaning device 5, as is, for instance, described in DE 100 63 572 A1. To this end, an opening 9 is again provided on the housing 8, with the individual components of the device 7 being arranged in the interior of the housing 8 of this opening 9 in a manner as to enable cleaning with CO₂ dry ice by simply introducing the welding torch 2. The supply with energy and control of the device 7 are effected by the common components and, in particular, the power supply 12, the controller 10 and the input/output device 11.

It goes without saying that also the selection of the respective device 6 or 7 can occur automatically. In this case, the cleaning device 5 may be connected with a welding apparatus 4, as is schematically illustrated in FIG. 2, and/or a robot 14 via appropriate lines so as to permit a data exchange between the units or apparatus via said lines. If, for instance, a particular welding material, i.e. an appropriate welding wire 1, is selected at the welding apparatus 4, and/or a special welding torch 2 is used, which can only be cleaned by a special cleaning method, the relevant data can be transmitted to the cleaning device 5. These data will be evaluated by the controller 10 arranged in the cleaning device 5, and the respective device 6 or 7 for cleaning the welding torch 2 will be activated and used.

In this respect, it is, for instance, also possible that the welding apparatus 1 or robot 14, prior to every cleaning process, informs the cleaning device 5 about the type of welding torch 2 and/or welding material or welding wire 1 used, so that the respective device 6 or 7 will be activated by the cleaning device 5. In doing so, it is, for instance, possible for the cleaning device 5 to retransmit the respective position, i.e. the respective opening 9 of the device 6, 7 into which the welding torch 2 must be introduced, so as to enable the robot 14 to correctly position the welding torch 2 and, hence, clean the welding torch 2. Such a data exchange in a simple manner renders feasible the use the cleaning device 5 for different welding units employing the most different welding torches 2 and/or welding materials or welding wires 1, since a data exchange will always take place prior to each cleaning procedure so as to enable the selection of the best device 6 or 7 possible. Hence, several robot units 14 are, at the same time, able to use a single cleaning device 5, which will ensure considerable cost savings.

According to FIG. 3, the individual, different devices 6, 7 for cleaning the welding torch 2 can also be arranged on at least one mounting plate 17 arranged in the interior of the housing 8 in an adjustable, for instance pivotable, vertically adjustable etc. manner. Hence, just one opening 9 will be required on the housing 8 to introduce the welding torch 2, with the respective components or assemblies being allocated to the opening 9 in the interior of the housing 8. In this case, the mounting plate 17 is connected with an adjustment means 18 so as to enable the respective device 6 or 7, or components of the same, to be positioned relative to the opening 9 by accordingly controlling the adjustment means 18. If, for instance, a different component or assembly is required for a welding torch 2 that is positioned in the opening 9, the mounting plate 17 will be lowered prior to being rotated, and the respective component will be selected only after this, such that the welding torch 2, by the lifting of the mounting plate 17, will again be positioned in the same. This has the advantage that a single position need be programmed in robotic welding units 14 and the welding torch 2 can, hence, be held in this position by the robot 14 over the entire cleaning process so as to permit an even faster cleaning of the welding torch 2. Thus, also a very rapid installation of the cleaning device 5 is ensured, since only one position need be programmed at the robot 14 and the alternating sequences between the individual components or assemblies are defined by the manufacturer of the cleaning device 5.

Moreover, the welding torch 2 to be cleaned, in a thus combined cleaning device 5 or thus combined cleaning apparatus, as explained by way of the previously described FIGS. 1 to 3, can sequentially pass through the different devices 6, 7 by being positioned and cleaned in all, or a defined selection, of the available devices 6, 7 or components. Particularly good cleaning results of the welding torch 2 will, thus, be achieved by the different cleaning processes. Additional cleaning devices or cleaning appliances known from the prior art, such as, for instance, mechanical cleaning devices in the form of milling means, can be integrated in the housing 8 in addition to, or instead of, the devices 6, 7, wherein all of the devices 6, 7 used for the cleaning of the welding torch 2 preferably have a common power supply 12, control device 10, input/output device 11 and, optionally, further common components.

It is also possible to incorporate additional components or assemblies in the cleaning device 5. When using a liquid or cleaning liquid for the magnetic cleaning process, liquid residues will frequently remain on the welding torch 2. In order to eliminate such residues, a blower means 19 may be arranged in the cleaning device 5. This blower means 19 is preferably arranged in a manner separate from the opening 9 for cleaning the welding torch 2 such that blown-off liquid will not contact the other components of the cleaning device 5. To this end, the housing 8 may have a separate opening 9, through which the welding torch 2 is introduced upon completion of the cleaning procedure, as is schematically illustrated in FIG. 3. The function of the blower means 19 is to blow an appropriate air stream onto the welding torch 2 so as to blow off any liquid residues present on the welding torch 2. In order to optimally clean liquid residues from the welding torch 2, a high-pressure air blower may, for instance, be used. A detailed illustration of the blower means 19 is obviated, since any blower means known from the prior art may be used for this purpose, requiring just a structural adaptation for mounting.

1-7. (canceled)

8. A cleaning device for cleaning welding torches, including a device for the electromagnetic cleaning of the welding torch, which is comprised of a coil having an opening for the introduction of the welding torch and, optionally, a device for the application of cleaning fluid to the tip of the welding torch, wherein, in addition to the device (6) for magnetic cleaning, at least one further device (7) for cleaning the welding torch (2) is provided, which further device (7) is configured to clean the welding torch (2) with a cold medium, in particular CO₂ dry ice, wherein the cleaning devices (6, 7) are arranged in a common housing (8), that a common controller (10), a common input/output device (11) and a common power supply (12) or current source for the control, adjustment and energy supply of the cleaning devices (6, 7) are arranged in the housing (8), and that, furthermore, a blower means (19) is arranged, in particular, in the housing (8) to remove liquid residues from the welding torch (2) after the cleaning process.

9. A cleaning device according to claim 8, wherein a waste container is arranged in the housing (8) to receive the cleaned-off impurities.

10. A cleaning device according to claim 8, wherein the devices (6, 7) are arranged in the interior of the housing (8), wherein openings (9) are provided on the housing (8) for the introduction of the welding torch (2).

11. A cleaning device according to claim 8, wherein the devices (6, 7) for cleaning the welding torch (2) are arranged on at least one mounting place (17) which is adjustably positioned in the housing (8).

12. A cleaning device according to claim 8, wherein further devices (6, 7) for cleaning welding torches (2), such as, for instance, mechanical cleaning devices in the form of milling means, are integrated in the housing (8) in addition to, or instead of, a device (6, 7).
